(19) United States
(12) Patent Application Publication
(10) Pub. No.: US 2008/0169763 A1
(43) Pub. Date: Jul. 17, 2008

(54) Plasma driven, N-Type semiconductor light source, thermoelectric power superoxide ion generator with critical bias conditions

(76) Inventors: Doug Burke, Newport Beach, CA (US); Surya G.K. Prakash, Hacienda Heights, CA (US)

Correspondence Address: Douglas Burke, 2507 Port Whitby, Newport Beach, CA, 92660, US

(21) Appl. No.: 12/075,068

(22) Filed: Mar. 7, 2008

Related U.S. Application Data
(63) Continuation-in-part of application No. 11/227,634, filed on Sep. 15, 2005, now Pat. No. 7,365,956.
Application No. 11/227,634 is a continuation-in-part of application No. 10/867,296, filed on Jun. 14, 2004, now abandoned.

(51) Int. Cl. H05H 1/00

(52) U.S. Cl. 315/111.21

(57) ABSTRACT

A light generating plasma is produced inside a partially transparent barrier enclosure made specifically of N-Type semiconductive material, said plasma thus generating a thermal gradient across said barrier which drives electrons through said barrier via the thermoelectric power of said N-Type semiconductor, said electrons thus being liberated on the opposing side of said barrier where they interact with oxygen in the air to form the superoxide ion, O₂⁻, and a second electrode on said opposing being at a critical minimum negative bias potential to quench collateral production of positive ions and ensuring production only of negative, O₂⁻, ions, and said light emanating from said plasma being useful visible light when it is transmitted through said barrier and into the region outside of said enclosure.

### FIELD OF THE INVENTION

The proposed invention is a continuation in part of our earlier application, _U.S. patent application Ser. No. 11/227,634. The proposed invention is a means of generating ions in the air at atmospheric pressure, by way of a device which is also a light source. In particular the species of ion generated is the superoxide ion, O₂⁻. The superoxide ion being the desired species because of its ability to accommodate the benefit of cleaning the air. Simultaneously, the superoxide ion, O₂⁻ does not have the harmful effects of ozone, O₃, to humans. It is a continuation in part of my earlier application Ser. No. 10/867.296. The proposed invention is capable of producing only negative ions and zero positive ions. The means of doing this is novel and unobvious. Also the proposed invention can produce a predetermined ratio of positive and negative ions.

### BACKGROUND OF THE INVENTION AND PRIOR ART

There are various and sundry means of generating oxygen ion species. These involve arc discharge through the air. An early discourse on such discharge phenomenon is found in the text, “The Discharge of Electricity Through Gases,” Charles Scribner's Sons, New York: 1899. S.S. Thompson, “Lord Kelvin.” Another text is “Fundamental Processes of Electrical Discharge in Gases,” Leob, Leonard, B., John Wiley and Sons, 1939.

A more recent text, “Spark Discharge” by Bazelyan et al. explains the phenomenon of streamers quite nicely. The problem in discharging electricity through air is that air is stubborn. It takes energy to start the arc which results in a type of avalanche breakdown. This avalanche breakdown produces as arc in which electrons have a lot of energy. This is undesirable because these energetic electrons can cleave molecular oxygen, O₂, in half to produce atomic oxygen, O. This atomic oxygen can then react with molecular oxygen to produce ozone. Ozone is unwanted because of its proposed harmful effects to humans.

The proposed invention liberates electrons into the air at a low energy. Avalanche dielectric breakdown of the air is absent. The superoxide ion is formed in abundance as opposed to ozone.

Techniques of producing ions in air usually involve a sharp needlelike electrode. At the tip of such a needle the electric field gets very high and dielectric breakdown occurs. These needles can be coated with platinum and gently pulsed to limit ozone production. As a result, superoxide ion generation is also limited. Further, the small surface area of the needle head limits ion production.

Needlelike electrodes in ionization devices are ever present. For pending art see US Patent App. NO, 20040025695 to Zhang at al. Therein find discussion of a plurality of wires and ground plates at high voltage to produce dielectric breakdown of the air and thus generate ions. Also is found a discussion of the point ionizer. Both of these techniques involve high voltage exposed to the raw air to produce ions. These devices however also produce ozone. The high voltage arcing through the raw air produces ozone because of the phenomenon of avalanche.

Pulsed corona discharge microwave plasma, and dielectric barrier discharge devices are all reviewed in detail in “Prospects for non-Thermal atmospheric plasmas for pollution abatement”, McAdams, J. Phys. D.: Applied Physics, 34 (2001) 2810-2821.

The pulsed corona discharge and the microwave discharge device involve passing the raw air through the corona and or plasma. This will produce ozone. This is why these devices clean the air, ozone being a powerful oxidant. However, if there are no contaminants in the air the ozone does not get used and itself is a contaminant.

The dielectric barrier discharge device DBD shown in FIG. 1, referring to FIG. 1, find a first electrode, 101, a dielectric barrier, 103, a second electrode, 105, a region between the insulating dielectric barrier and the second electrode where air can pass, 107, and a power supply, 109.

In the dielectric barrier or silent discharge regime, one of the two electrodes has an insulating coating on it and an alternating current (ac) voltage is applied between the electrodes. The microdischarges occur between the insulating surface and the opposing electrode. These microdischarges have a duration of ˜1-10 ns and are self-quenching. They appear as spikes on the current waveform. For a given applied voltage, the capacitances of the insulating layer and the gap between the layer and the opposing electrode together with the applied frequency determine the power dissipation. Such dielectric barrier discharges have formed the basis of commercial ozone generators, with the ozone being used for water treatment for example.

The proposed invention is primarily not a dielectric barrier discharge device. In one of its permutations, it has a plasma in an enclosed volume and the barrier is a specific material to execute specific phenomenon. In yet another embodiment the enclosure has its outer surface held at a specific potential to achieve specific results.

The short discharge pulses in region, 107, of a DBD have a lot of energy and split molecular oxygen in half to the end of producing ozone. The proposed invention is not a dielectric barrier discharge device.

Ion tubes which generate ions and or ozone have been manufactured and used for many years. The bentax tube was reviewed in an earlier U.S. application Ser. No. 10/867,296. Other ion/ozone tubes are disclosed in U.S. Pat. No. 1,793,799 to Hartman (1931), U.S. Pat. No. 1,064,064 to Franklin (1913), U.S. Pat. No. 3,905,920 to Botcharoff, US. PAT. No. 361,923 to Brian (1887). These devices lack the novelties of the proposed invention in that the enclosure of the tube is not specified to be an N-type semiconductor. Also the critical bias potential of the secondary electrode, which is present in the proposed invention is absent in these earlier tubes.

Other means of generating negative ions include irradiating a conductor with an ultraviolet lamp to liberate electrons via the photoelectric effect. This method is employed in U.S. Pat. No. 3,128,378 to Allen et. al., U.S. Pat. No. 3,335,272 to Dickinson et. al., and U.S. Pat. No. 3,403,252 to Nagy. The proposed invention does not employ the photoelectric effect nor the use of ultraviolet light. The ultraviolet light can produce ozone, O₃, as well as atomic oxygen, O, both of which are undesirable.

In general the reason for producing ions in atmospheric air is for the purpose of cleaning the air. There are devices, which propose to be a light source and clean the air. The proposed invention claims to produce light and clean the air.

An example of a visible light source, which also produces ions, is the device made by “Ionlite”. Ionlite is the name of the product. This device is a compact fluorescent light bulb further included, outside the plasma chamber, is a bundle of what appears to be carbon fibers exposed to the air. When the device is turned on it produces visible light and negative ions. The apparent bundle of carbon fibers is the recipient of an applied voltage. The species of ions that this device produces however are harmful to humans. When ultra violet visible spectroscopy is done near the light bulb it is revealed that the device is producing carbon compound ions. Carbon compounds are known to be harmful to humans and do not serve to clean the air. The “Ionlite” can be reviewed at various websites including but not limited to www.ionlite.com. The device does not appear to have a patent issued or pending. The light source which is the proposed invention produces only the superoxide ion. It does not use carbon fibers as the ion generating means. It does not emit harmful compounds into the air.

Yet another device that produces visible light and also claims to clean the air is the titanium coated compact flluorscent light bulb. These can be found sold under the names “Fresh2 light” or “Ozonelight”. Access to their descriptions can be found at www.fresh2.com or www.ozonelite.com. Measurements reveal that these devices do not produce ions. The mechanism by which these devices are supposed to clean the air comprises the titanium oxide losing an electron by way of the ultra violet light emenating from the inner light chamber. As air passes over the surface of the bulb the titanium oxide coating supposedly oxidizes and cleans the air. The titanium oxide coated light bulbs do not produce superoxide ions. The proposed invention is a light source that does produce superoxide ions.

### BRIEF DESCRIPTIONS OF DRAWINGS

FIG. 1: Schematic of dielectric barrier discharge device

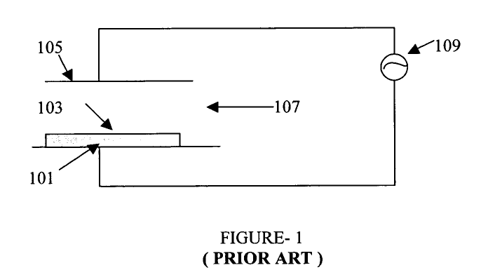

FIG. 2: Schematic of plasma enclosure light source with barrier and electrode

### OBJECTS AND ADVANTAGES

Accordingly several objects and advantages of the proposed invention are:

(a) The proposed invention comprises a plasma bound by a barrier wherein electrons are transported through the barrier by virtue of the thermo-electric power of the barrier. The barrier is an N-Type semiconductor instead of a P-Type semiconductor.

The charge carrier of the barrier in the proposed invention is the electron. It is possible to get a higher current of electrons through such a barrier than sodium ions through the P-Type barrier of the prior art. A higher current of electrons translates into a production of more superoxide ions.

(b) The primary mechanism of ion production is electron transport through the glass. The electron appears at the surface with a low energy. It collides with O₂ molecules and they capture it to become superoxide, O₂⁻. The energy input into the device goes onto heating the plasma to create the temperature gradient that drives electrons through the glass. The energy is not used to generate dielectric barrier discharge, which can generate ozone. Thus the proposed invention generates about ten times less ozone per unit energy input into the device that is for equal voltages and thickness of barrier. At the same time it produces about ten times more superoxide ions.
(c) The primary mechanism of ion production is the transport of electrons through the barrier. Thus a higher transport of electrons can be achieved by floating the inner electrode at a negatively biased DC offset. This establishes a net electric field across the barrier that does not time average out to zero. There is a net electric field producing a net force on electrons. This additional force increases the electron diffusion through the barrier which gives rise to more ions.
(d) In the proposed invention it is electron transport through the barrier and onto the surface of the tube that produces ions. The temperature gradient across the barrier pushes the electrons through the barrier. Thus increasing the temperature gradient can increase the ion production. Driving the plasma at the plasma frequency maximizes the temperature of the plasma. This is a critical resonant condition that results in an improvement of the ion output. The critical resonant frequency is a function of the density of the gas inside the tube and the partial ionization of the plasma.
(e) The inner electrode of the plasma in the proposed invention can be floated at a negative bias D.C. offset below ground. This serves to provide means for the device to produce mostly negative ions. The negative D.C. offset provides an electric field that drives more electrons through the glass. More electron transmission gives rise to more ion production.
(f) A novel unobvious improvement of our earlier application is that a critical offset voltage has been discovered for the secondary electrode which makes the device produce no positive ions, thus only negative ions are produced.
(g) The critical offset voltage can then be made to vary with time at resonant ion production frequencies.

### DETAILED DESCRIPTION OF THE INVENTION

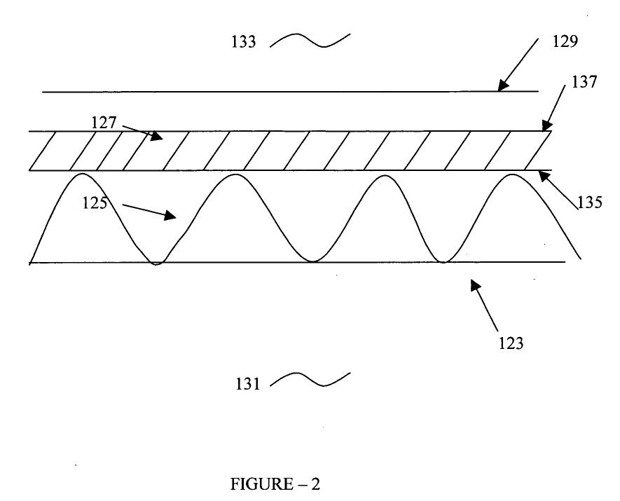

Referring to FIG. 2, the proposed invention comprises a first region containing a gas, 131, a first electrode, 123, a plasma, 125, formed by exciting said first electrode with an AC voltage, a barrier, 127, which separates said first region, 131, from a second region, 133, and a second electrode, 129, and said second region being the open air of the room where the device is placed, and said barrier having an inner surface, 135, and an outer surface, 137. Said plasma being a light source wherein light emanating from said plasma travels through said barrier. Thus said barrier must be composed of a material that is partially transparent to said light. Said light being in the visible spectrum so that it may be useful as a light source in conditions where light is needed.

Said gas is of a stoichiometry and pressure so that when said second electrode is excited with the appropriate AC voltage light is generated by way of the plasma created. Said light is of the form, which may have wavelengths in the ultra violet range that need to be converted to longer less harmful wavelengths. This is achieved by the addition of a coating on either the inner surface, 135, or the outer surface, 137, of said barrier. The coatings that can be used are selected from the group consisting of phosphorescent materials which are commonly used in most fluorescent lights. Thus the device described is a fluorescent light that produces superoxide ions.

Said gas can be a stoichiometry comprised of a mix of mercury and an inert gas such as nitrogen or xenon. The mercury is in the gaseous state only when the plasma is activated.

Said second electrode, 129, can be a partially transparent conducting or semiconducting material deposited directly onto said outer surface so that light emanating from said plasma can enter said second region where it is useful.

Said second electrode, 129, can also be a metallic mesh, or it can be a metal deposited directly onto the outer surface, 137, of said barrier. If it is deposited directly it must have open regions such that there are regions on said outer surface, 137, where said metal deposition is absent. A cross hatched pattern of metal deposition would be one such arrangement. The reason for this is so electrons coming to the surface can have some space to move before they hit the second electrode. This allows time for them to be picked up by oxygen molecules in said second region thereby generating the superoxide ion, O₂⁻.

Said barrier is a dielectric material whose dielectric breakdown limit is such that the voltage applied to said first electrode does not cause dielectric breakdown through said barrier.

In one embodiment, the barrier is composed of a glass, which has extrinsic defects that create channels by which thermal electrons can leak through the barrier.

In another embodiment the barrier is any of the known partially transparent glass or ceramic materials that are N-Type semiconductors, wherein the charge carrier is the electron.

A first group of electronically conducting glasses consist of oxide glasses with relatively large concentrations of transitron metal oxides, such as vanadium phosphate glasses.

A second group of electron glasses consists of sulphides, selenides, and tellurides. These are known as the chalcogenide glasses. These glasses are semiconductors but their electronic conductivity is not critically dependent on trace impurities as it is in the classical semiconductors. However, with the transition metal oxide glasses there is generally a dependence on the degree of reduction or oxidation during melting; the conductivity is generally at a maximum for a certain ratio of oxidized to reduced valence state of the transition metal ion. (Linsley, G. S., Owen., A. E. and Hayatee, F. M. (1970). J. Non-Crystalline Solids, 4, 208).

Electronically conducting glasses have a definite thermoelectric effect. This has been observed by Mackenzie. [Mackenzie, J. D. (1964) “Modem Aspects of The Vitreous State”, Vol. 3, p. 126. Butterworth. London.] The thermoelectric power of the barrier turns out to be important as will become obvious in the section on operations of the invention. The temperature gradient across the barrier is the dominant force that drives electrons through the barrier. This electron current is proportional to the product of the thermoelectric power of the material and the temperature gradient.

The second electrode, 129, is held at a critical bias potential of at least −230 Volts. This negative voltage on the second electrode quenches the production of positive ions. It is unusual that this voltage is only −230 Volts. The second electrode is desired to be set at ground because it is exposed to the air. Since the −230 Volts is not a “high voltage” it can be applied to the second electrode safely. Namely, if it is applied with a power supply that cannot put out more than 1 mA, it is still safe to be touched by human hands without danger. The second electrode's voltage can also be made sinusoidal and negatively biased. This enhances the production of ions.

The supporting electronics to drive the light is all accomplished by known means. The bias potential of the outer electrode is supplied by a standard negative DC potential source. The AC voltage is applied to the inner electrode with a standard AC source with the appropriate inductive coupling to achieve the impedance match between the AC source and the plasma. The starter switch circuitry required to get the plasma started is the standard circuitry present in fluorescent lights.

### Operation of the Invention

Referring to FIG. 2, a voltage is applied to said first electrode, 123, to form a plasma, 125. The plasma temperature is greater than the temperature in region two, 133. In particular, the electron temperature in the plasma is greater than the temperature in said second region, 133 . This establishes a temperature gradient across said barrier, 127. Said barrier is an N-Type semiconductor wherein the majority charge carrier is the electron. Said barrier has a thermoelectric power, P. Thus the temperature gradient pushes electrons from the plasma through said barrier. The electrons appear on the surface of said barrier and interact with the molecular oxygen in said second region, 133. The free electrons plus molecular oxygen produce the superoxide ion, O₂⁻. The negative bias on the second electrode, 129, repels the electrons so they do not disappear into the ground before they become O₂⁻.

Light emanating from said plasma ,125, passes through a coating on the inner surface of said barrier, 135, where it undergoes a frequency shift by interacting with the coating thereon. The light then passes through said partially transparent barrier, 127, and through said second electrode, 129, and into said second region, 133.

We claim:

1. A system for producing visible light and superoxide ions in the air at atmospheric pressure comprising:
a. an enclosed volume of gas, the inside of which comprises a first region, the outside of which comprises a second region, the boundary of which comprises a barrier between said first and second regions and said second region being atmospheric air, and,
b. a first electrode in said first region and first subvolume between said first electrode and said barrier is, and
c. a second electrode on the outer surface of said barrier, and
d. said second electrode having holes so that gas in said second region can move to and from the outer surface of said barrier, and
e. said barrier being composed of a material selected from the group consisting of glass or ceramic materials which are N-Type semiconductors wherein the majority charge carrier is the electron, and
f. said barrier being partially transparent to visible light, and
g. means for holding said second electrode at a potential below ground, that is a negative potential, and
h. means of applying an AC voltage of adequate amplitude and frequency to said first electrode to sustain a partially ionized plasma in said first subvolume, and
i. the thickness of said barrier being thin enough that a plasma is generated in said first subvolume and thick enough so that dielectric breakdown does not occur in said barrier, and the interaction of said plasma with said barrier and said negatively biased second electrode and said atmospheric air in said second region thus producing negative ions in said second region, and
j. said gas, when excited into a partially ionized plasma in said first subvolume by way of said AC voltage applied to said first electrode, being of a pressure and stoichiometry such that its plasma produces visible light.

2. The method and system of claim 1 wherein said second electrode is at a negative potential at least 230 volts below ground.

3. The method and system of claim 1 wherein said second electrode is at a negative potential between −230 volts and −500 volts below ground.

4. The method and system of claim 1 wherein said second electrode is at a negative potential between −230 volts and −1000 volts below ground.

5. The method and system of claim 1 yet further including a coating on the inner surface of said barrier, and said coating serving to change the frequency of light emanating from said plasma before it passes into said second region ,and said coating being selected from the group consisting of materials which exhibit phosphorescent properties.

6. The method and system of claim 1 wherein said second electrode is a partially transparent conducting or semiconducting material deposited directly onto said outer surface so that light emanating from said plasma can enter said second region where it is useful.

7. The method and system of claim 1 wherein said second electrode is a partially transparent conducting or semiconducting material deposited directly onto a portion of the outer surface of said barrier, such that a portion of said outer surface is without said electrode one arrangement being a cross hatched pattern or any arrangement ordered or disordered.

8. The method and system of claim 1 wherein said second electrode is metal or semi-metal deposited directly onto a portion of the outer surface of said barrier, such that a portion of said outer surface is without said electrode one arrangement being a cross hatched pattern or any arrangement ordered or disordered.

9. The method and system of claim 1 wherein said barrier is composed of borosilicate glass.

10. The method and system of claim 1 wherein said barrier is composed of material selected from the group consisting of chalcogenide glasses , the sulphides, selenides, and tellurides.

11. The method and system of claim 1 wherein said barrier is composed of a material selected from the group consisting of transition metal oxide glasses.

12. The method and system of claim 1 wherein said barrier is composed of a material selected from the group consisting of vanadium phosphate glasses.

13. The method and system of claim 1 wherein said barrier is composed of a material selected from the group consisting of transition metal oxide glasses wherein the ratio of oxidized valence state transition metal ions to the reduced valence state transition metal ions is adjusted so that the thermo electric power is at a maximum.

14. The method and system of claim 1 wherein said barrier is composed of a material selected from the group consisting of amorphous N-Type semiconductors wherein the majority charge carrier is the electron.

15. The method and system of claim 1 wherein said gas in said first region is selected from the inert gases.

16. The method and system of claim 1 said second electrode is varying with time and is always at a negative potential below ground.
